(19) United States
(12) Patent Application Publication
(10) Pub. No.: US 2010/0028225 A1
(43) Pub. Date: Feb. 4, 2010

(54) CAPILLARY PROTECTIVE COVER

(76) Inventors: Stephen Edward Gatz, Morrison, IL (US); Manuel Louis Gonzalez, II, Sterling, IL (US)

Correspondence Address: General Electric Company;GE Global Patent Operation, PO Box 861, 2 Corporate Drive, Suite 648, Shelton, CT, 06484, US

(21) Appl. No.: 12/183,641

(22) Filed: Jul. 31, 2008

(51) Int. Cl. B01J 19/00; F16L 57/00; B05D 3/00; B23P 19/04

(52) U.S. Cl. 422/291; 427/401; 29/460; 138/89

(57) ABSTRACT

A protective cover for a pinch-off end of a capillary tube is provided. Protective cover comprises a wicking member comprising a structure with a plurality of voids, said wicking member configured to cover said pinch-off end, and a protective coating.

### BACKGROUND OF THE INVENTION

1. Field of the Invention

The present invention relates in general to metallic capillary tubes and, more particularly, to an apparatus and method to cover a sealed end of a capillary tube.

2. Description of the Related Art

It is well known to control the temperature in an area, such as a room, by use of refrigerating devices such as, for example, air conditioners. Operation of these refrigeration devices is typically controlled in part by use of a switching device which cycles a compressor ON and OFF in response to the temperature of the air passing from heat exchange relationship with the evaporator into the temperature controlled area. Such compressor cycling enables the refrigerating device to maintain a temperature within a predetermined range in the temperature controlled area.

In such refrigeration devices, various temperature sensing devices and condition responsive mechanisms are used to sense temperature changes and operate in response to such temperature changes. These sensing devices may comprise, for example, an expansible bellows that is retained within a housing and that is also in communication with a generally elongate metallic capillary tube. Such bellows and tube are charged with a temperature sensitive pressure fluid, such as a liquid or a gas. The fluid in the capillary tube contracts and expands with temperature, which in turn drives the bellows to operate. The operation of the bellows, in turn, causes an opening and closing of a set of electrical contacts at predetermined temperatures for energizing and de-energizing a compressor.

Referring to FIG. 1 of the drawings, there is illustrated a generalized capillary tube and bellows assembly (1). A metallic capillary tube (2) having a generally cylindrical sidewall (3) with an unsealed open end (4) and a crimped, sealed end (7). The capillary tube open end (4) is in operable communication with an expansible bellows (6) retained within a bellows housing (5). The metallic capillary tube (2) is charged with a temperature sensitive pressure fluid (not shown). Typically, the temperature sensitive pressure fluid (not shown) is a refrigerant, such as R-134A, for example. Open end (4) of the capillary tube (2) is sealedly attached by solder (8) into the bellows housing (5). The solder (8) also acts to seal the temperature sensitive pressure fluid (not shown) within the bellows housing (5). A bellows retainer (9) cooperates with the bellows housing (5) to retain the expansible bellows (6) within the housing (5). The capillary tube and bellows assembly (1) are sealed so as to create a closed system and retain the temperature sensitive pressure fluid (not shown) within the capillary tube and bellows assembly (1). Changes in gas pressure at the capillary tube open end (4) resulting from expansion and contraction of the temperature sensitive pressure fluid (not shown), due to changes in local temperature, act to drive the bellows (6). The travel of the bellows (6) is calibrated to open and close a set of electrical contacts (not shown) at predetermined temperatures in operable communication with the compressor.

It is important that the aforementioned capillary tube be well sealed in order to ensure the pressure fluid remains confined therein. Numerous arrangements are known for crimping, i.e. closing and sealing, one or both ends of the aforementioned capillary tube. One typical arrangement is to flatten the tube in a limited region thereof and thereafter effecting a welding operation on such flattened region. In another typical crimping arrangement, a metallic capillary tube has its opposite sides collapsed inwardly between a pair of crimping jaws, and while confining these collapsed opposite sides, another pair of crimping jaws is operated to collapse a portion of the tube with sufficient force to sever the tube forming a tapering cold welded end thereon. Still another crimping method utilizes self-aligning and self-adjusting crimping and severing dies to effect not only a squeeze seal on the capillary tube but also a metallurgical pinch-off seal forming a metal-to-metal diffusion for sealing the severed end of the capillary tube.

Referring to FIG. 2 of the drawings, there is illustrated the capillary tube (2) having a generally cylindrical sidewall (3) extending about a capillary opening or passage (8) through the tube (2). Often, the capillary tube (2) is formed of a thermally conductive, malleable base material, such as copper or aluminum, for example. The capillary tube (2) is also often further plated with a thin layer of a thermally conductive material, such as tin for example, in order to protect against corrosion and further facilitate soldering the unsealed end of the tube (4) into the bellows housing (5).

Typically, one end of the tube (2) is pinched-off and/or crimped to form an at least temporary seal. The pinch-off and/or crimping operations often result in the formation of sharp edges (18) on the tube (2) in the vicinity of the crimped end (7). Thereafter, the crimped tube end (7) may be permanently sealed by welding or soldering. The crimping and sealing the end (7) of the capillary tube (2) provides a seal to prevents egress of the temperature sensitive pressure fluid (not shown).

Many known prior art crimping arrangements have the drawback of forming of sharp knife-like edges in the vicinity of the crimped end. These edges can be sharp enough to require careful handling to avoid injury to personnel, as well as to avoid damage to equipment during installation. Another drawback of prior art crimping and sealing arrangements, specifically when applied to capillary tubes that have a protective plating thereon, is that the various crimping and pinch-off operations often remove or otherwise deplete the aforementioned protective plating in the vicinity of the pinch-off region. Such removal of the protective plating material exposes the base metal of the capillary tube, hastening corrosion.

In order to overcome the above described hazardous conditions, and to further protect the crimped end portion of the capillary tube, it is known to apply, via welding or soldering, a protective covering comprising a mass, such as a drop or globule of solder, for example. This protective covering of solder is fixedly attached via a manual soldering operation to the sealed end. This manual operation requires some degree of skill to perform and is time consuming, and therefore costly. Additionally, the manual operation and is difficult to control and can result in significant variation in the size and shape of the solder ball protective cover. In many instances, oversized solder ball protective covers can prohibit installation into desired locations.

Another alternative to overcome the aforementioned shortcomings of the crimping and sealing operations known in the art is to form the tube end using a die cast operation. This method typically yields a sealed tube end without sharp edges and enables close control of the tube end dimensions. However, the die cast process is known to produce flash, in the form of a thin region of waste material in the vicinity of the die parting line that must be removed in a secondary operation. The die cast operation also has relatively high initial cost as well as ongoing costs required to maintain the die tooling.

### BRIEF DESCRIPTION OF THE INVENTION

In view of the foregoing considerations, one objective of the present invention is to provide an improved cover and a method of attaching a cover for the pinch-off end of a capillary tube which overcomes the drawbacks of some of the prior art.

In one aspect of the invention a protective cover for a pinch-off end of a capillary tube is provided wherein said cover comprises a wicking member comprising a structure with a plurality of voids, said wicking member configured to cover said pinch-off end, and a protective coating.

In another aspect of the invention, a method for covering a pinch-off end of a capillary tube is provided, comprising providing a wicking member comprising a bore locating said pinch-off end of said capillary tube within said bore, adhering a protective coating to said wicking member and said end of said tube.

In another aspect of the invention, a method for covering a crimped end of a temperature control apparatus of the type having a metallic capillary tube with an open end and said crimped end, said open end in operable communication with an expansible bellows, and said capillary tube charged with a temperature sensitive pressure fluid, is provided comprising providing a wicking member comprising a bore locating said pinch-off end of said capillary tube within said bore and adhering a protective coating to said wicking member and said end of said tube.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings. The accompanying drawings, which are incorporated in and constitute a part of the specification, illustrate a presently preferred embodiment of the invention, and together with the general description given above and the detailed description of the preferred embodiment given below, serve to explain the principles of the invention, wherein:

FIG. 1 Illustrates a typical generalized temperature controls comprising a capillary tube and expansible bellows assembly.

FIG. 2 Illustrates a capillary tube with a crimped pinch-off end.

FIGS. 3a and 3b Illustrate an exemplary wicking member of the type of the present invention comprising a coil as in FIG. 3a, and a perforated tube as in FIG. 3b.

FIGS. 4a, 4b, and 4c Illustrate the steps of forming the protective cover of the present invention through a solder dip process.

FIGS. 5a, 5b, and 5c Illustrate a capillary tube with a crimped pinch-off end with sharp edges; the crimped end of a capillary tube over which the tubular member of the type of the present invention is placed; and the end of a capillary tube with the finished protective coating of the cover of the present invention

### DETAILED DESCRIPTION OF THE PREFERRED EMBODIMENTS

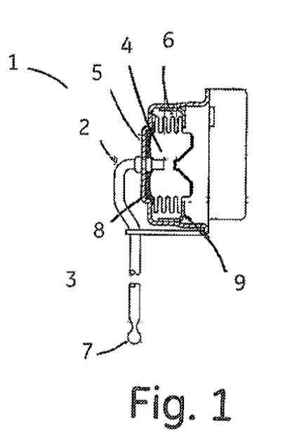

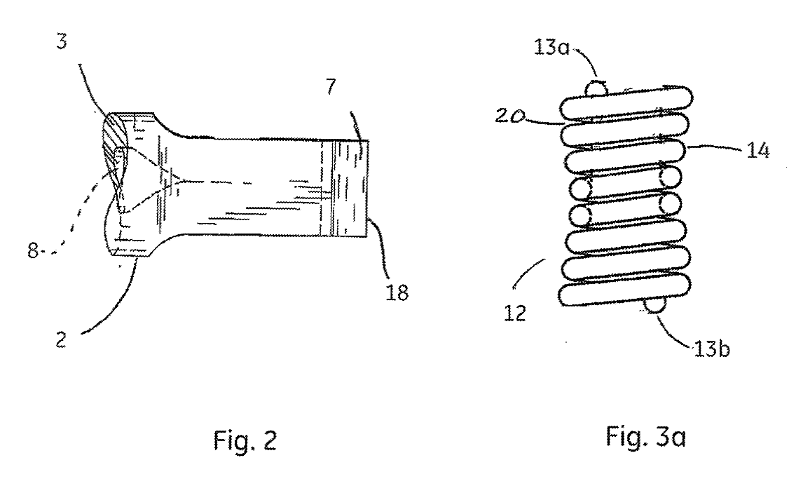

In describing present invention, reference will be made herein to FIGS. 1-5 of the drawings in which like numerals refer to like features of the present invention. Referring now to the drawings, wherein like reference numerals designate identical or corresponding parts throughout the several views, one of the embodiments of the current sensing apparatus of the invention will be described. One of the advantageous aspects of an embodiment of the invention described here is a novel and improved cover and a method of attaching a cover for the pinch-off end of a capillary that is less costly and more convenient to manufacture.

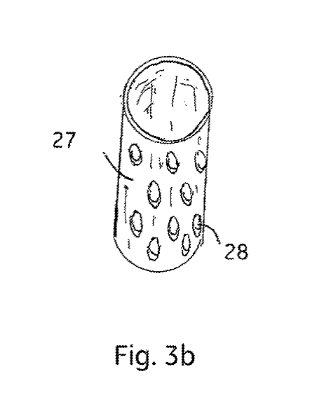

Referring to FIG. 3a of the drawings, there is illustrated an exemplary wicking member (12) of the type of the present invention comprising a coil or wound spring. The wicking member (12) preferably comprises steel or other metal wire approximately 0.016 in. (0.41 mm) diameter. It will be appreciated that the wire dimension may vary in other embodiments without departing from the scope of the invention. The spring may be wound for example, with 8-10 turns (14), defining a bore therein and such that a void (20) is formed between each the turns (14). In one embodiment, for example, the windings at each end (13a and 13b) are closed. It will be appreciated that other materials, including e.g., alloys and composites, are contemplated for use in fashioning a wicking member (12) in the practice of the present invention.

The inside diameter of the wicking member (12) preferably provides for a tight or interference fit with the outside diameter of the capillary tube (2). For example, for a capillary tube (2) having outside diameter approximately 0.078 in. (1.98 mm), the inside diameter of the wicking member (12) windings (14) would preferably be approximately 0.052 in. (1.32 mm). Additionally, it is preferred, for example, that the minimum diameter of the spring bore be approximately one-half the maximum outside diameter of the spring turns (14).

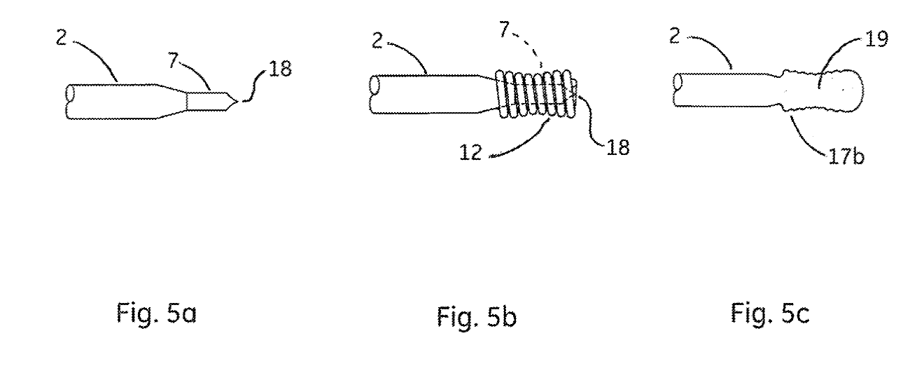

Subsequent to the forming and pinching-off of the tube end (7), the wicking member (12) is placed on the pinched-off crimped end (7) of the capillary tube (2) as shown in FIG. 5b. Referring also to FIG. 3b of the drawings, there is illustrated an exemplary wicking member of the present invention comprising a perforated sleeve (27) with a plurality of perforations (28). It will be appreciated that the spring and the perforated sleeve are shown in FIG. 3a and FIG. 3b for illustrational purposes only and generally any suitable geometric configuration that is generally tubular and comprising a plurality of voids may be employed. As used herein, the term “void” refers to any opening, gap, or separation in the structure of the wicking member, including for example, the gaps between the turns of a coil. Additionally, for example, it is possible that a mesh or other non-cylindrical shapes may be employed in the practice of this invention depending upon the application.

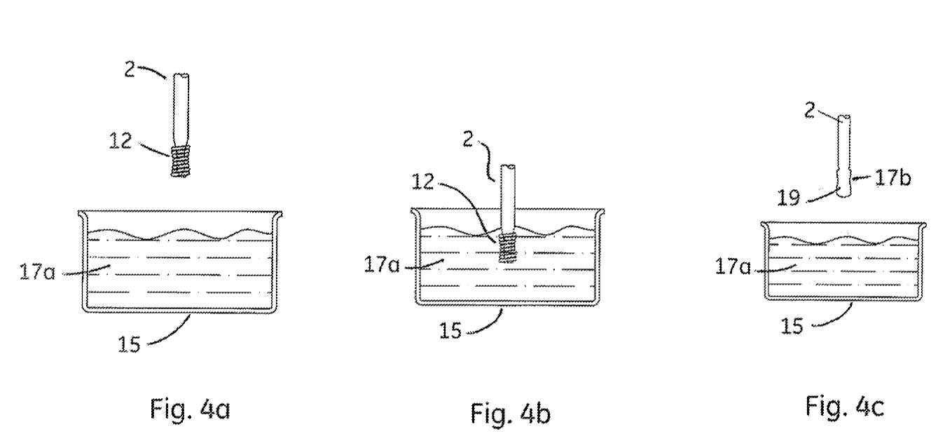

Turning now to FIGS. 4a, 4b, and 4c, subsequent to the placement of the wicking member (12) on the capillary tube (2), the wicking member (12) is adhered using a substance, such as a metallic solder, that preferably requires a minimum curing time and preferably fills at least a portion of the voids of the wicking member (12). To achieve this, the crimped end (7) of the capillary tube (2) is moved or otherwise positioned so as to be disposed with respect to a source, such as a container (15) having suitable welding and/or dipping material therein, such as molten solder or tin (17a). In this arrangement, the wicking member (12) and the crimped end (7) of the capillary tube (2) are briefly placed or dipped at least once into the molten tin (17a) in a solder dip process and then removed. In this manner, the molten tin (17a) flows or wicks between the voids of the wicking member (12), preferably coating wicking member (12) and the crimped end (7) of the capillary tube (2) and curing to form a preferably hardened tin coating (17b). In an exemplary embodiment, the coating (17b) fixedly adheres the wicking member (12) to the crimped end (7) of the capillary tube (2). Additionally, the sharp edges (18) formed during crimping or pinch-off of the tube (2) are covered by a protective cover (19) comprising the wicking member (12) and the tin coating (17b). The capillary tube (2) and wicking member (12) may separately be plated prior to the solder dip process to enhance the bond during the solder dip process.

Referring to FIG. 5a, there is illustrated the pinched-off crimped end (7) of the capillary tube (2) showing the sharp edge (18) formed during pinch-of process. Further, in FIG. 5b, there is illustrated the wicking member (12) placed over the pinched-off crimped end (7) of the capillary tube (2). Referring to FIG. 5c, there is illustrated the protective cover (19) formed after dipping the wicking member (12) and crimped end (7) of FIG. 5b into molten solder (17a) as illustrated in FIGS. 4a and 4b.

With respect to the above description, it should be realized that the optimum dimensional relationships for the parts of the invention, to include variations in size, form function and manner of operation, assembly and use, are deemed readily apparent and illustrated in the drawings and described in the specification are intended to be encompassed only by the scope of appended claims.

In addition, while the present invention has been shown in the drawings and fully described above with particularity and detail in connection with what is presently deemed to be practical and several of the preferred embodiments of the invention, it will be apparent to those of ordinary skill in the art that many modifications thereof may be made without departing from the principles and concepts set forth herein. Hence, the proper scope of the present invention should be determined only by the broadest interpretation of the appended claims so as to encompass all such modifications and equivalents.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope claims, or if they include equivalent structural elements with insubstantial differences from the literal languages of the claims.

What is claimed is:

1) A protective cover for a pinch-off end of a capillary tube, said cover comprising:
a wicking member comprising a structure with a plurality of voids said wicking member configured to cover said pinch-off end, and
a coating,
wherein said coating essentially covers said wicking member and said pinch-off end of said tube.

2) The protective cover of claim 1 wherein:
said wicking member comprises a coil.

3) The protective cover of claim 1 wherein:
said wicking member comprises a perforated sleeve.

4) The protective cover of claim 1 wherein:
said protective coating comprises a thermally conductive material.

5) The protective cover of claim 1 wherein:
said wicking member comprises a thermally conductive material.

6) The protective cover of claim 1 wherein:
said wicking member is configured to provide an interference fit over said tube.

7) A method for covering a pinch-off end of a capillary tube, comprising:
providing a wicking member comprising a bore;
locating said pinch-off end of said capillary tube within said bore;
adhering a protective coating to said wicking member and said end of said tube.

8) The method of claim 7 wherein;
said wicking member comprises a coil.

9) The method of claim 7 wherein:
said wicking member comprises a perforated tube.

10) The method of claim 7 wherein:
said wicking member comprises a thermally conductive material.

11) The method of claim 7 wherein:
said wicking member is a thermally conductive material.

12) The method of claim 7 wherein;
said wicking member comprises a thermally conductive material.

13) The method of claim 7 wherein:
said protective coating comprises a thermally conductive material.

14) The method of claim 7 wherein:
said wicking member is configured to provide an interference fit over said tube.

15) A temperature control apparatus of the type having a metallic capillary tube with an open end and a crimped end, said open end in operable communication with an expansible bellows, and said capillary tube charged with a temperature sensitive pressure fluid, said crimped end having a protective cover, said protective cover comprising:
a wicking member comprising a structure with a plurality of voids,
said wicking member configured to cover said pinch-off end, and a coating,
wherein said coating essentially covers said wicking member and said pinch-off end of said tube.

16) The apparatus of claim 15 wherein:
said wicking member comprises a coil.

17) The apparatus of claim 15 wherein:
said coating comprises a thermally conductive material.

18) A method for covering a crimped end of a temperature control apparatus of the type having a metallic capillary tube with an open end and said crimped end, said open end in operable communication with an expansible bellows, and said capillary tube charged with a temperature sensitive pressure fluid, said method comprising:
providing a wicking member comprising a bore locating said pinch-off end of said capillary tube within said bore;
adhering a coating to said wicking member and said end of said tube.

19) The method of claim 18 wherein:
said wicking member comprises a coil.

20) The method of claim 18 wherein;
said protective coating comprises a thermally conductive material.
